(19) United States
(12) Patent Application Publication
(10) Pub. No.: US 2016/0059329 A1
(43) Pub. Date: Mar. 3, 2016

(54) CIRCULAR SAW BLADE

(71) Applicant: LEDERMANN GMBH & CO KG, Horb Am Neckar (DE)

(72) Inventors: Dominique FENDELEUR, Souffelweyersheim (FR); William WEISS, Wolfisheim (FR)

(21) Appl. No.: 14/839,804

(22) Filed: Aug. 28, 2015

(30) Foreign Application Priority Data
Aug. 29, 2014 (FR) 1458132
May 7, 2015 (EP) 15166741.7

(51) Int. Cl. B23D 61/02; B23D 61/04

(52) U.S. Cl. CPC B23D 61/021; B23D 61/04

(57) ABSTRACT

The circular saw blade includes a blade body having the form of a disc, and a plurality n (n>1) of teeth inserted into the peripheral rim of the blade body so as to be distributed over the circumference of the disc. Each tooth generates a chip derived from the machined material. There is a cut-out for the clearance of the chip being provided in the peripheral rim of the blade body at the level of each tooth, and incorporating a base seat to which the tooth is soldered. For at least one tooth, the cut-out defines a volume for clearance of the chip which is less than the apparent volume of the chip generated by a tooth.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates to a sawing device for sawing a material like wood, metal, plastic, etc. This sawing device comprises at least one circular saw blade. This blade has the particularity of being very minimally noisy as compared to the conventional blades used in circular saws.

2. Description of Related Art Including Information Disclosed Under 37 CFR 1.97 and 37 CFR 1.98

Indeed, whether in the case of a stationary machine (table saw or miter saw) or portable machine, a traditional blade emits a deafening noise right from the moment of its being set in rotation, whether it be at rest, under vacuum, or during the cutting. This noise, of the order of 90 dB to 100 dB is relatively bothersome for the person who is working with the machine, as well as for those persons who happen to be in the vicinity of the machine. Before the advent of new regulations, the reduction of noise had become a priority for manufacturers of tools.

The noise is mainly caused by the air circulating in the hollow spaces that are situated upstream of each tooth at the level of the toothed peripheral rim of the blade. The air that rushes in between the teeth while the blade rotates causes an unpleasant loud hissing or whistling noise. In certain conditions that are even more unfavourable, the body of the blade may also begin to resonate and thus become a source of noise.

Thus, as can be seen in the attached FIG. 1, in the case of a mouth A made of two blades B and C forming an angle between them so as to join each other on a line of contact with the surface S to be treated, the deformation of the blades B and C when they are applied against said surface S causes the withdrawal of the blade B in front of the surface S, with respect to the other blade C, and this distance will generate, at the end of the path, a small stream of water F, which will not be sucked. The higher the pressure, the larger will be the deformation and the larger will also be the stream of water.

In order to reduce this noise that is generated from the blade, it is a known technique to make grooves in the blade. Here reference is made to laser etchings. These grooves are distributed over the entire blade body and are localized at specific spots/locations so as to locally reduce the amplitude of the vibrations of the blade. They can be filled with a viscoelastic material that serves as a shock absorber. Their role consists in limiting the vibration when the blade is in motion, and noise is consequently slightly reduced.

Another solution, often combined with the first solution, consists of removing the hollow spaces that are situated upstream of each tooth, in order for the peripheral rim of the blade to be as linear as possible between the teeth. This solution is very effective, and makes it possible to drastically reduce the noise, so as to thereby achieve a noise level that is less than 75 dB. The disadvantage that is presented is that the chips formed during the sawing no longer have the space to be discharged around the teeth, which leads to a risk of blocking of the machine with abnormal heating, and to a detachment of the teeth. In order to overcome these drawbacks, the operator is thus obliged to reduce the blade feed rate so as not to generate extremely large chips. As a consequence thereof, certain cuts may no longer be made/achieved.

### SUMMARY OF THE INVENTION

The objective of the present invention is to provide a circular saw blade whereof the noise emitted is minimal, that is to say, less than 70 dB, and which can operate in a machine at full capacity, with optimal chip discharge/evacuation. This blade is designed with the objective of improving user comfort and ease of use of the machine.

The sawing device for sawing a material according to the invention comprises, in a conventional manner:
a blade body having the form of a disc;
a plurality of teeth inserted into the peripheral rim of the blade body in a manner so as to be distributed over the circumference of the disc, each tooth generating a chip derived from the machined material.

A cut-out for clearance or removal of the chip is provided in the peripheral rim of the blade body at the level of each tooth, incorporating a base seat to which the tooth is attached, this being brazed thereon.

This device is characterized mainly in that, for at least one tooth, the said cut-out defines a volume for clearance of the chip which is less than the apparent volume of the chip generated by a tooth.

Whereas the latest technological advances mentioned here above recommended the elimination of the cut-out to allow for chip clearance in order to reduce the noise, the present invention takes the opposite stance and requires a cut-out to allow for the chip clearance, but with a very specific characteristic feature as compared to the conventional blades.

Up to the present time, in a conventional blade, it had been considered that the cut-out had to define a volume for chip clearance that is greater than the apparent volume of the chip generated by a tooth. This theory, which consists in providing for sufficient space for the chip, in particular when the latter is twisted into a comma-shaped form and then a corkscrew and becomes quite large, has never been called into question.

The main idea of this invention is based on going against the grain of this technical prejudice, by reversing the situation. Indeed, it turns out that the chip, as and when it is generated, is perfectly able to be discharged by means of a space that is less than its apparent volume without, creating a blockage in the machine.

The positioning of the teeth on the peripheral rim of the blade can in this regard be arbitrary, that is to say, it may obey a uniform distribution or not. In the event of non-uniform distribution, the teeth are not placed at an angular pitch. However, the characteristic feature presented here above continues to still be applicable regardless of the configuration selected, including in the event of a variable pitch:the volume for clearance of chips for at least some teeth is less than the apparent volume of the chip generated by these teeth.

Similarly, the peripheral rim of the blade body may have at least one recess replacing k (k≧1) tooth (teeth), each recess thus defining a clearance volume that is less than the apparent volume of chips generated by the k tooth (teeth) replaced.

In practice, the chip clearance volume is equal to the chip clearance surface delimited by the cut-out, multiplied by the cutting width of the blade. The distance between the two ends of the cut-out, that is to say the opening of the cut-out, must be sufficient in order for a brazing machine to be able to access this zone and come to fix the tooth on to the seat. The cutting width of the blade corresponds to the width of the tooth.

The apparent volume of the chip is equal to the actual volume of the chip generated by a tooth multiplied by an expansion coefficient R which depends on the material being machined. In concrete terms, the apparent volume of the chip corresponds to the external casing envelop of the twisted chip, consequently thus including the hollow zones, whereas the volume of the chip corresponds precisely to the volume of the material constituting the chip. The expansion coefficient in fact makes it possible to pass from the volume Vs of the chip to the apparent volume V of the chip, V being equal to Vs multiplied by the expansion coefficient: V=Vs×R.

In the prior art, the expansion coefficient R has always been considered to be in the order of 3 to 7, depending on the material being machined. This is a historically accepted parameter, the relevance of which has never been called into question in the case of circular saws. The present invention takes the opposite stance of this historical technical prejudice, by proposing that it is in reality comprised between 2 and 4.

The invention can also be applied to configurations in which the peripheral rim of the blade body includes two groups of teeth, the teeth of a first group being oriented in the direction opposite to that of the teeth of a second group. This relates in fact to saw blades which are able to cut in both directions.

One of the advantages of this invention is that it is at present possible to manufacture a blade that can perform effectively regardless of the number Z of teeth. Thus far, the geometry of the cut-out for the chip clearance had been dictated by the number of teeth, and thus by the distance between two adjacent teeth. The blade according to the invention does not take into account the number Z of teeth, because the geometry of the cut-out for the clearance or removal of the chip is based on the apparent volume V of the chips, taking into account the new estimate of the expansion coefficient R.

More precisely, in the designing of a circular saw blade, the determination of cut-outs begins as has been noted by a calculation that serves to arrive at the apparent volume V of the chip, a calculation which requires the initial starting parameters that are included in the table presented here below.

| Input Parameter | Symbol | Size |
|---|---|---|
| Blade: exterior diameter | D | mm |
| Blade: cutting width | ab | mm |
| Machine: speed of rotation | N | Tr/min |
| Machine: feed rate | vf | m/min |
| Machine: cutting height | ae | mm |
| Machine: blade extension/ | u | mm |
| material: | | |
| Chip: expansion coefficient | R | — |

In order to obtain the values of the variables to be used to calculate the actual volume of a chip, that is to say, typically the average length, the average width and the average thickness, preliminary calculations are necessary, of which the calculation of the feed rate per tooth (fz), which corresponds to the linear distance traveled by one tooth during one rotation:

$$fz = \frac{vf}{Z * N}$$

Then, the calculation of the angle of engagement (φe), which corresponds to the angle formed by the teeth which are engaged in the material to be cut:

$$Φ e = arccos ( \frac{D - 2 * ae - 2 * u}{D} ) - arccos ( \frac{D - 2 * u}{D} )$$

It is then possible to perform the calculation of the average thickness of the chip (hm) formed by a tooth and which has a real form shaped like a comma:

$$hm = \frac{fz}{√ D} * ( \sqrt{u} + \sqrt{u + ae} )$$

Then the calculation of the average length of the chip (Ib) formed by a tooth and which depends on the number of teeth engaged:

$$l b = \frac{π * D * Φ e}{360}$$

And finally the calculation of the volume of the chip (Vs) generated by a tooth:

Vs=hm*Ib*ab

The apparent volume of the chip (V) generated by a tooth is finally, as has already been indicated:

V=Vs*R

Based on that, it is possible to define the geometry of the chip clearance cut-out, by starting from the main characteristic feature upon which the invention is founded, which is that the volume of chip clearance (V_{DGC}) must be less than the apparent volume of the chip (V): V_{DGC}≦V

However, the volume of the chip clearance (V_{DGC}) is obtained by multiplying the chip clearance surface (S_{DGC}) by the cutting width (ab):

V_{DGC}=S_{DGC}*ab

It is therefore sufficient to select a chip clearance surface (S_{DGC}) which is less than the apparent volume of the chip (V) divided by the cutting width (ab):

$${S}_{DGC} \leq \frac{V}{ab}$$

This chip clearance surface is greatly reduced as compared to the prior art. The shape of the chip clearance cut-out is in practice chosen in such manner as to provide sufficient space in front of the seat so as to be able to easily attach the tooth and to grind it if needed, while also providing the ability, during use, to guide the chips generated. This form of the chip clearance cut-out is therefore adapted based on the size of the tooth and cutting angles chosen.

According to the invention, the cut-out is delimited on either side by two straight portions seemingly parallel and connected to each other by a rounded portion and a first linear part of the seat, one of the straight portions constituting a second linear part of the seat, the two parts of the seat being perpendicular to each other.

According to one possible configuration, the peripheral rim of the blade lying between two adjacent cut-outs consists of a rounded sector that is concentric with the circle initially defined by the disk of the blade body and approaching its periphery. The profile of the blade body is optimized in this case in a manner such as to ensure that the removal of material from the original disc is minimal. The fact that the peripheral rim of the blade is close to the perfect circle makes it possible to mitigate the noise to a considerable degree, since there exists virtually no more hollow space where the air could rush in.

However, in this configuration, a small hollow space has nevertheless been added in the proximity of each tooth. More precisely, a hollow recess has been formed in the said rounded back of the blade downstream of each tooth and juxtaposed with the corresponding seat. The function of this hollow recess is to prevent any overheating of the blade in the cutting zone, which could damage the blade.

According to another possible configuration, the peripheral rim of the blade lying between two adjacent cut-outs consists of a rectilinear sector. The profile of the blade body is however optimized in a manner such as to ensure that the removal of material from the original disc is minimal. The reduction of noise is lower than in the previous configuration, however the restoration of the tool to working condition is facilitated.

In an advantageous manner, in the context of what has come to be known as extendable systems, in order to increase the cutting width, the sawing device according to the invention may include two identical blades positioned side by side along their central axis of rotation, each blade being provided with a plurality of recesses each formed in the peripheral rim thereof between two adjacent cut-outs, the said blades being offset by one angular pitch in a manner such that each tooth of one blade is found positioned to be facing a recess of the other blade. This means that between two adjacent teeth of a first blade, are found both a recess through which appears a tooth of the second blade, and a chip clearance cut-out. In the prior art, the opening of the chip clearance cut-out was so far extended that the tooth of the second blade appeared therein, without the need to add a recess. However, this large cut-out gave rise to a significant level of noise. Replacing this large cut-out with a small cut-out plus a recess makes possible a significant degree of noise reduction during operation of the sawing device.

The scope of application of the present invention will become more apparent from the detailed description presented here below. The detailed description and the examples that follow, indicating preferred embodiments of the invention are provided by way of illustration only, potential changes and modifications consistent with the spirit and scope of the invention may possibly become apparent to the person skilled in the art from this detailed description.

### BRIEF DESCRIPTION OF THE DRAWINGS

The invention will henceforward be described in greater detail, with reference being made to the appended figures.

FIG. 1 is a schematic view of a saw blade cutting a wooden board.

FIG. 2 shows a schematic view of a chip generated by a tooth.

FIG. 3a is a front elevation view of a tooth of a sawing device having a single blade.

FIG. 3b is a front elevation view of two teeth of an extendable system with two blades.

FIG. 4 is an enlarged schematic view of a portion of the peripheral rim of a saw blade according to the prior art.

FIG. 5 shows a schematic view of a portion of the peripheral rim of a saw blade according to a first possible configuration of the invention having a linear peripheral sector between two cut-outs.

FIGS. 6 and 7 illustrate a front elevation view and a partial sectional view, respectively, of a saw blade according to a second possible configuration of the invention with sectors separating two rounded cut-outs.

FIGS. 8 and 9 represent a front elevation view and a partial sectional view of a saw blade used in an extendable system.

FIG. 10 is a perspective view showing the extendable system consisting of two blades according to the FIGS. 8 and 9.

FIGS. 11 and 12 show a general front elevation view and a partial enlarged front elevation view, respectively, of the extendable system represented in FIG. 10.

FIG. 13 represents a front elevation view of a saw blade according to a variant embodiment of the invention comprising recesses distributed in an asymmetrical manner over the peripheral rim.

### DETAILED DESCRIPTION OF THE DRAWINGS

The present With reference to FIG. 1, a saw blade is represented in the process of cutting a wooden board. The blade comprises a blade body (1) and a plurality of teeth (2). Various different parameters have been annotated on the blade and the board, in particular:
D: the diameter of the blade;
N: the speed of rotation of the blade;
vf: the feed rate of the blade;
ae: the cutting height of the blade, here corresponding to the thickness of the board;
u: the extension of the blade relative to the board;
fz: the feed rate per tooth;
φe: the angle of engagement.

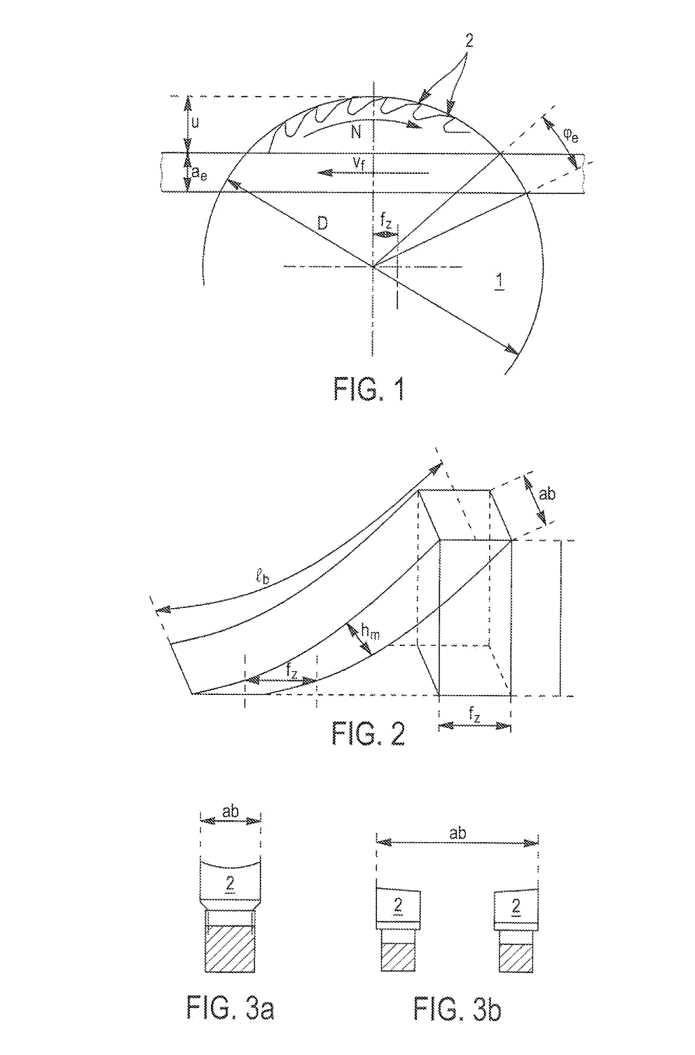

During the cutting of the board, chips are obviously generated. These chips have the appearance of a comma shaped form during the initial stage, as shown in FIG. 2, prior to getting twisted so as to form a helical chip.

The volume of the chip shaped like a comma corresponds to its length (Ib) multiplied by its width (ab) multiplied by its thickness (hm). The feed rate per tooth (fz) is also represented in order to be able to imagine the volume that the chip would have if it had been represented by a parallelepiped form instead of a comma.

The width (ab) of the chip corresponds the cutting width (ab) of the sawing device. If the device has only one single blade, then the cutting width (ab) will be equal to the width of the tooth (2), as illustrated in FIG. 3a, whereas if the device includes two blades arranged in parallel, the cutting width (ab) will then be equal to the width of the two blades measured at the level of the teeth (2) as is shown in FIG. 3b. These figures show a particular example of the teeth which is quite obviously not intended to be limiting.

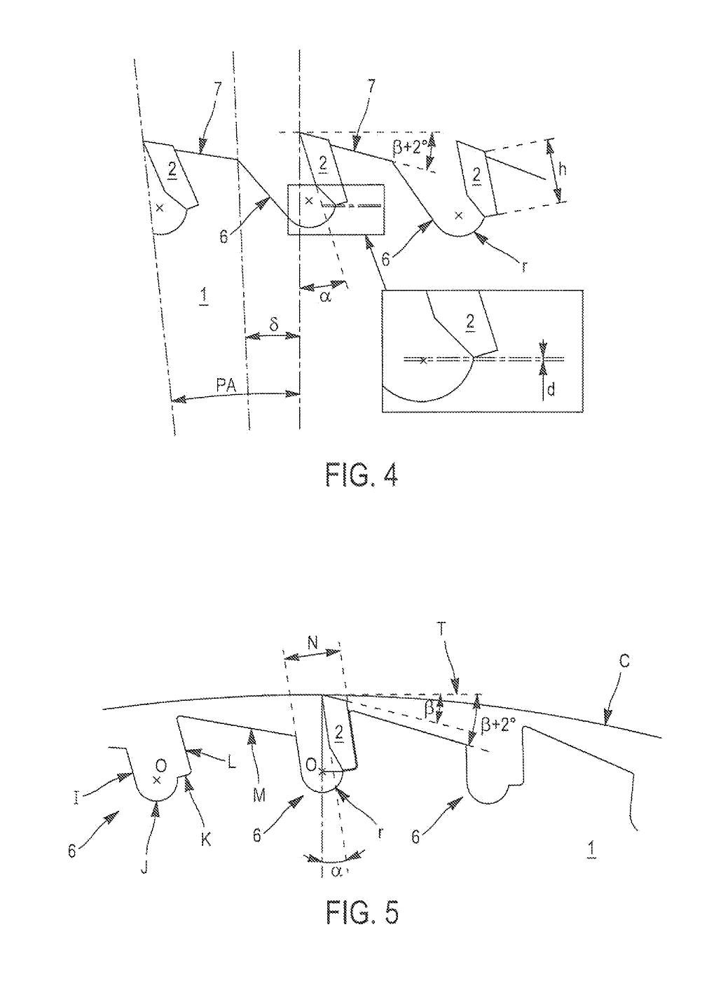

In a general manner, a blade comprises a plurality of teeth (2) inserted into the peripheral rim of the blade body (1). The FIG. 4 shows an enlarged view of a peripheral rim of a blade provided by the prior art. Situated upstream of each tooth (2) is a cut-out (6) for clearance of the chip, followed by a ramp (7) terminating at a cut-out (6) of the teeth (2) adjacent thereto. Each tooth (2) is attached, generally by means of brazing, in a base seat formed for this purpose in the cut-out (6) for the chip clearance.

In the prior art, as illustrated in FIG. 4, the geometry of the cut-out (6) for chip clearance is dictated by the circumferential pitch, and therefore depends on the number of teeth (2) present on one blade.

In the following sections, and in order to show the difference in technical approach resulting from the invention, an example of the conventional method for calculating the geometry of the cut-out (6) is given.

In this context, the input parameters used are as follows:
Z=number of teeth on a blade;
D=diameter of the blade;
P=circumferential pitch=(π*D)/Z;
PA=angular pitch=360°/Z;
h=height of the tooth (2);
a=angle of attack of the tooth (2).

The following parameters are then to be defined in order to obtain the geometry of the cut-out (6):
r=radius of clearance;
d=distance between the lowest point of the seat and the centre of the radius r of clearance;
δ=angle between the tip of the tooth (2) and the start of the cut-out (6).

Through experience, and in accordance with various different assumptions of configurations corresponding to predetermined intervals applied to selected input parameters:

If P≧16 and α>0 then:

r=P/6

d=r*0.08

δ=PA*0.4

If P≧16 and α≦0 then:

r=P/6

d=0

δ=PA*0.4

If P<16 and h<10.5 then:

r=P/6.5

d=0

δ=PA*0.40

If P<16 and h≧10.5 then:

r=P/6.5

d=0

δ=PA*0.45

From these geometries, there results in any event a surface of chip clearance that is relatively large and open, and is therefore a source of noise both when the blade is rotating in vacuo and when the blade is cutting.

The blade according to the invention, represented in FIGS. 5 to 7, possesses, at the level of each tooth (2), a cut-out (6) for chip clearance the geometry of which does not depend on the number of teeth (2) attached to the peripheral rim of the blade. The design of the cut-out (6) is effected around the tooth (2) itself, and then the external contour remaining between two adjacent teeth (2) is made by filling with a view to coming closer to the initial profile of the disc that constitutes the blade body (1).

As it has been previously described above, the surface of the cut-out SDGC should not exceed a threshold which depends only on the diameter and the cutting width of the blade, the machine parameters, and the expansion coefficient, as it results from the calculations performed here above. The surface of the cut-out SDGC obtained ultimately is significantly smaller than in the prior art, however it still allows for the passage of chips and the proper operation of the blade.

The cut-out (6) includes, as illustrated in FIG. 5:
a first part I, corresponding to a straight line;
a second rounded part J corresponding to a portion of a circle having a radius r and centre O;
and a third linear part K corresponding to the depth of the base seat on which the tooth (2) is positioned;
a fourth linear part L corresponding to the height of the base seat, and to the line that is parallel to the part I.

Two adjacent cut-outs (6) are connected to each other by a part M corresponding to a clearance or relief ramp. This ramp M defines a clearance or relief angle β formed between this ramp M and the circle C described by the teeth of the blade. By taking the tangent T to this circle C at the cutting edge of the tooth (2), the angle formed with the ramp M corresponds to the clearance or relief angle β to β+2°.

The opening of N of the cut-out (6) corresponds to the distance between the parts I and L.

This opening N varies according to the thickness of the tooth (2). It is necessary to ensure that there is always sufficient space between the part I and the tooth (2) in order to enable the brazing of the tooth (2) on to its seat, as well as, optionally, the passage of the grinding wheel with the angle of attack. This space may not be less than 2.0 mm, in the light of currently available technical means for attachment. It is possible that this space may be further reduced in future years with the emergence of new technologies.

For example, for a thick tooth (2) made of tungsten carbide, the opening N may vary between 4.5 mm and 8 mm.

For a tooth (2) made of diamond, of lesser thickness than a carbide tooth (2), the opening N may drop down to 3.5 mm.

Once the opening N and the seat depth K have been defined, the rounded part J may be drawn. It simply connects the part I to part K.

The centre O of the circle of this rounded part J is located on the radius of the disc of the blade passing through the cutting edge of the tooth (2).

The teeth (2) may have multiple different lengths, generally comprised between 2.5 mm and 15 mm.

The angle of attack α of the tooth (2) may vary from −10° to +30°.

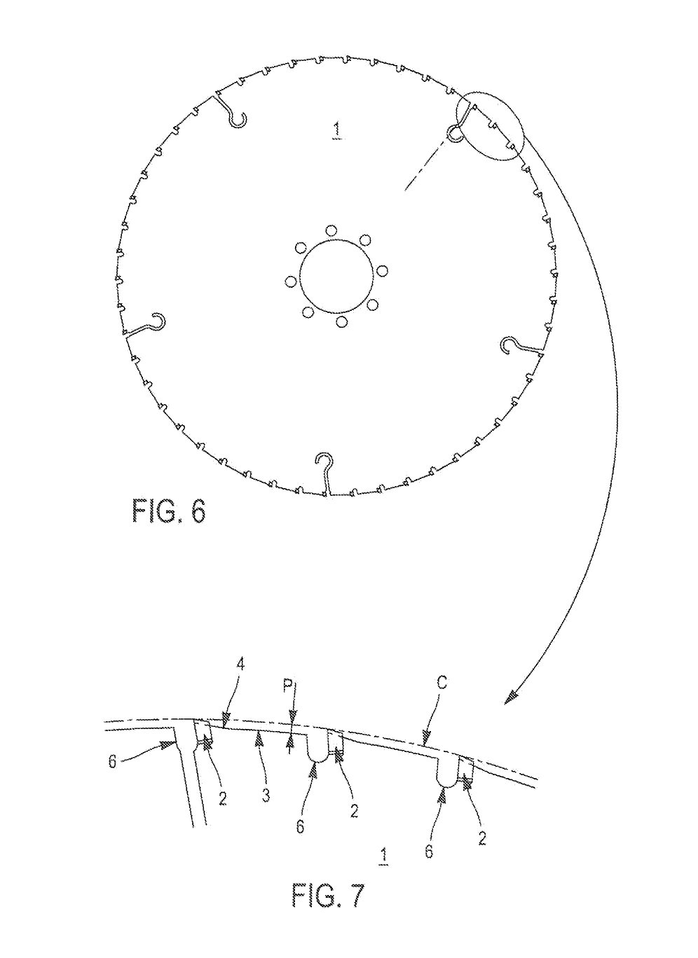

FIG. 6 presents a complete blade according to one particular case of embodiment of the invention. FIG. 7 shows more precisely the technical details which vary with respect to the case presented in FIG. 5.

The geometry of the cut-out for the chip clearance is identical to that shown in FIG. 5. Only the part M is different, in that the clearance or relief ramp is replaced by a rounded back (3) that is concentric with the circle C defined initially by the disk of the blade body (1). A hollow recess (4) is formed in this back (3), immediately downstream of the tooth (2). The distance P between the rounded back (3) and the circle C is about 0.8 mm.

Quite obviously it is possible that there may be other configurations, with the cut-outs for chip clearance having geometries that are different from that represented in the FIGS. 5 to 7, as long as the characteristic features of the invention are found therein.

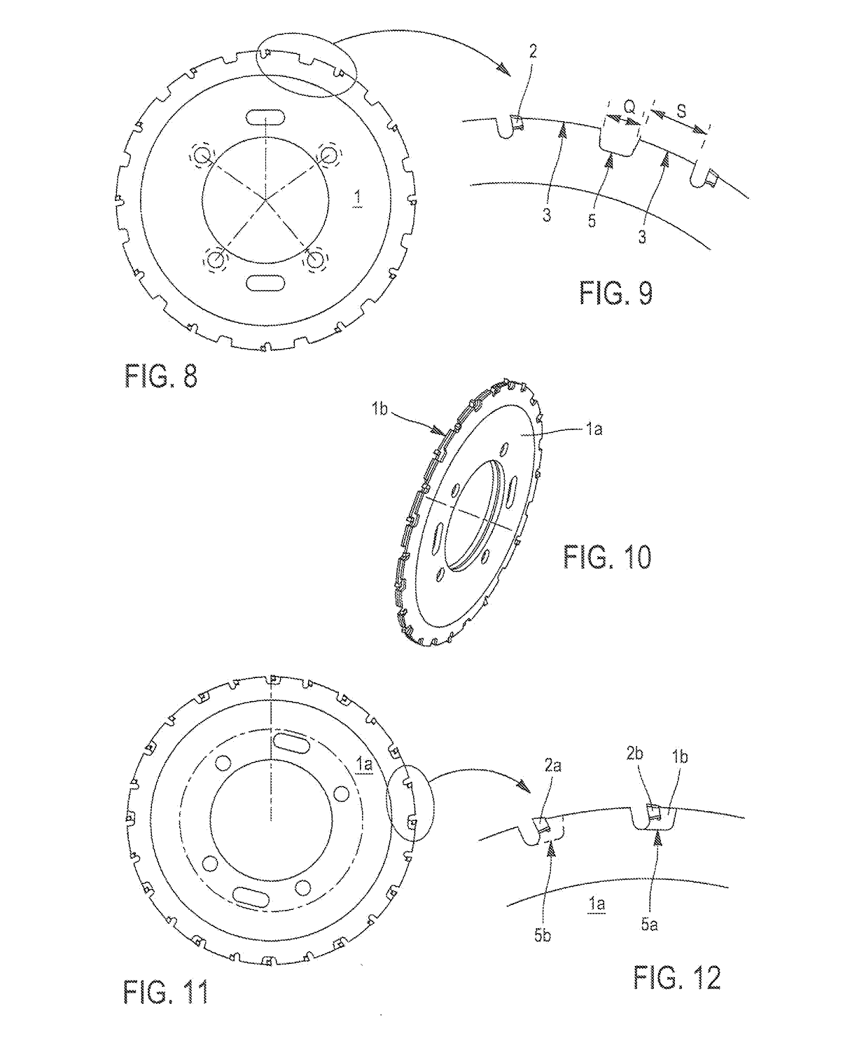

FIGS. 8 to 12 show what is referred to as an extendable system, that is to say an assembly of two saw blades that are adapted to be mounted in a sawing device, in order to increase the cutting width.

Such a saw blade is represented individually in FIG. 8. In addition to all of the characteristic features previously presented above, this blade comprises a plurality of recesses (5) formed in its peripheral rim in a manner so as to ensure that there is one recess (5) between two adjacent teeth (2). This recess (5) is dimensioned in a manner so as to provide an opening Q which is at least equal to the opening N of the cut-out for chip clearance. Indeed, the aim is to assemble together two identical blades, by shifting them to be off-set by one angular pitch, in such a way that each tooth (2) of a blade is found to be positioned facing a recess (5) of the other blade, as illustrated in the FIGS. 10 to 12. The opening Q of the recess (5) must therefore be sufficiently wide so as to cause a tooth (2) to appear with its corresponding cut-out but not excessively large so as to not generate noise.

In the example shown in FIGS. 8 and 9, the opening of the recess measures 5.4 mm, and it is located at a distance S measuring 9.49 mm from the part I of the adjacent downstream cut-out.

In FIGS. 10 and 11, the two blades are assembled together, and the blade bodies (1a, 1b) are offset by one angular pitch. Thus, in FIG. 12, it can be seen that the tooth (2b) and a small piece of a first blade body (1b) appear through the recess (5a) formed on the peripheral rim of the second blade body (1a), the recess (5b) formed on the peripheral rim of the first blade body (1b) being located in the background of the tooth (2a) attached to the second blade body (1a).

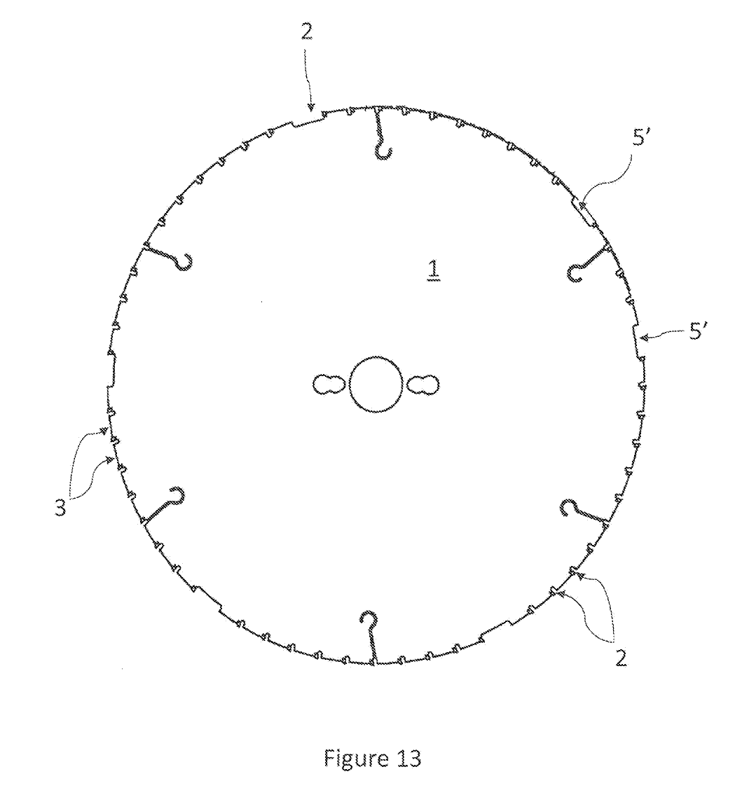

With reference to FIG. 13, the variant represented shows a saw blade (1) that includes recesses (5′) distributed in an irregular manner over the peripheral rim, resulting in the absence of teeth at certain locations. In this case, according to the invention, each recess (5′) defines a clearance volume (VDGC) that is less than the apparent volume (V) of the chips generated by the replaced teeth (2), in this case 6 in number.

The configurations shown in the figures cited are only possible examples, without in any way being limiting, of the invention that on the contrary, encompasses the variants in terms of form and design that may be within reach of the person skilled in the art.

1. A circular saw blade comprising:
a blade body being comprised of a disc;
a plurality n (n>1) of teeth inserted into a peripheral rim of said blade body so as to be distributed over a circumference of said disc, each tooth generating a chip derived from machined material;
a cut-out for clearance or removal of a respective chip being provided in said peripheral rim of said blade body at a level of each tooth, and incorporating a base seat, a respective tooth being soldered to a corresponding base seat;
wherein said cut out (6) defines a volume for clearance of a respective chip less than an apparent volume of the chip generated by a corresponding tooth for at least one tooth.

2. The circular saw blade, according to claim 1, wherein said peripheral rim of said blade body has at least one recess replacing k (k≧1) tooth, each recess defining a clearance volume less than an apparent volume of chips generated by the k tooth replaced.

3. The circular saw blade, according to claim 1, wherein said chip clearance volume (V_{DGC}) is equal to a chip clearance surface (S_{DGC}) defined by said cut-out, multiplied by cutting width of said blade body.

4. The circular saw blade, according to claim 1, wherein apparent volume of the chip (V) is equal to the actual volume of the chip (Vs) generated by a tooth multiplied by an expansion coefficient depending on material being machined.

5. The circular saw blade, according to claim 4, wherein said expansion coefficient is comprised between 2 and 4.

6. The circular saw blade, according to claim 1, wherein said peripheral rim of said blade body comprises two groups of teeth, the teeth of a first group being oriented in the direction opposite to a direction of the teeth of a second group.

7. The circular saw blade, according to claim 1, wherein said cut-out is defined on either side by two straight portions, being parallel and connected to each other by a rounded portion and a first linear part of the base seat, one of the straight portions forming a second linear part of the base seat, said first linear part and said second linear part being perpendicular to each other.

8. The circular saw blade, according to claim 1, wherein said peripheral rim of said blade body lying between two adjacent cut-outs is comprised of a rounded sector concentric with a circle initially defined by said disc of said blade body.

9. The circular saw blade, according to claim 8, further comprising a hollow recess formed in said rounded sector downstream of each tooth and juxtaposed with the corresponding seat.

10. The circular saw blade, according to claim 1, wherein said peripheral rim of said blade body lying between two adjacent cut-outs is comprised of a rectilinear sector.

11. The circular saw blade, according to claim 1, wherein said blade body is comprised of two identical blades positioned side by side along their central axis of rotation, each blade being provided with a plurality of recesses, each recess formed in the peripheral rim thereof between two adjacent cut-outs, the said blades being offset by one angular pitch in a manner such that each tooth (2) of one blade is found positioned to be facing a recess of the other blade.
